(19) United States
(12) Patent Application Publication
(10) Pub. No.: US 2017/0248453 A1
(43) Pub. Date: Aug. 31, 2017

(54) Sensor Unit for Measuring the Mass Flow of the Solid Phase of Biogenic Multi-Phase Flows and Fluidic Parameters of the Gaseous Phase

(71) Applicants: Technische Universität Dresden, Dresden (DE); miunske GmbH, Grosspostwitz (DE)

(72) Inventors: Thomas Herlitzius, Coswig (DE); Christian Korn, Dresden (DE); Jörg Bernhardt, Bannewitz (DE); Matthias Grimsel, Haselbachtal (DE); Peter Mitlöhner, Ebersbach-Neugersdorf (DE); Martin Gössel, Grosspostwitz/O.L. (DE); Sebastian Müller, Ohorn (DE); Stephan Kirstein, Grosspostwitz/O.L. (DE)

(21) Appl. No.: 15/441,272

(22) Filed: Feb. 24, 2017

(30) Foreign Application Priority Data
Feb. 26, 2016 (DE) 102016203079.5

(51) Int. Cl. G01F 1/66; A01F 12/44; A01F 12/32; G01F 13/00; A01D 41/127

(52) U.S. Cl. CPC G01F 1/661; G01F 13/001; A01D 41/1272; A01F 12/32; A01F 12/446

(57) ABSTRACT

A sensor unit for use in the multiphase flow of a harvesting machine, wherein the sensor unit exhibits sensors for transmitting and/or receiving electromagnetic radiation. In addition, the sensor unit has at least one device for acquiring flow parameters of the multiphase flow. The measuring values of the sensor unit can advantageously be used for controlling the operating mode of the harvesting machine.

### CROSS REFERENCE TO RELATED APPLICATIONS

This application claims the priority of DE 102016203079.5 filed on 2016 Feb. 26; this application is incorporated by reference herein in its entirety.

### BACKGROUND

The present invention relates to a device for measuring the solid phases in multiphase flows, in particular for metrologically recording the grain load of the transport and/or separation airflow of a combine harvester and the fluid mechanical variables of the gaseous phase. A multiphase flow, in particular a biogenic multiphase flow, is understood below as a flowing air/plant part mixture, in which the air represents the gaseous phase, and the plant parts, in particular the grains, represent the solid phase. In particular, the phases can also exhibit even just partially varying directions of movement within the framework of separation processes.

The invention will be described based on the example of the mobile machine of a combine harvester. Harvesting grain is an important method for recovering agricultural crops, and essentially involves the procedural steps of mowing, threshing, separating and cleaning. This process chain is realized within a combine harvester according to prior art (FIG. 1).

Heterogeneous site conditions for the plants as well as climate changes during the day require a constant adjustment of machine parameters, so as to achieve a maximum grain throughput at the lowest possible level of grain loss and the best possible capacity utilization of the combine harvester on the traversed stretch.

To this end, the machine has changeable manipulated variables (e.g., blower speed, sieve opening widths, several different adjustable sieves, threshing concave gap width, threshing drum speed, . . . ), which can be used to influence throughput, threshing and separating quality.

Among other things, the productivity of the machines is limited by an incomplete separation of grains at the shaker or rotor separating elements and the cleaning device. The unseparated grains are lost to the field again. The location and time resolved detection of the separation rate of the separating elements can provide measured variables for automated machine setting. Important variables here include the mass flow of solid particles of biogenic multiphase flows (e.g., density of grain-non grain constituent mixture under the sieve or shakers/rotors, number of grains and non-grain constituents) as well as fluid mechanical variables for the gaseous phase (flow rate, static pressure, . . . ).

In machines according to prior art, the solid phase of the grain separated by a functional element (shaker, rotor, cleaning device) is frequently measured by piezoelectric sensors or vibration sensors. In light of the following disadvantages, the mentioned functional elements of a combine harvester cannot be reliably controlled with the existing sensors for measuring the solid phase:
The sensors are positioned in or at the edge of the multiphase flow.
Only a partial area of the solid phase is acquired.
Due to the existing measuring principle, the sensor signal is influenced by the properties of the constituents of the solid phase.
Measuring errors arise owing to foreign bodies located in the solid phase to be measured.

The passing crop stream cannot be precisely monitored with the used piezoelectric sensors. The measurement of fluid mechanical variables for the gaseous phase is currently not yet being realized.

Beyond that, a series of additional methods is known for ascertaining the loading of the conveying streams in harvesting machines with plant parts to be used.

DE 10 2013 107 169 A1 proposes that the conveying stream (crop stream) be observed with imaging sensors, and that the broken grain or non-grain percentage be determined. The results are both visualized and used for controlling the working device. The disadvantage here is that image recognition is a complicated procedure still fraught with significant uncertainty.

US 2008/0171582 A1 proposes that the plant parts of interest be optically excited, so that the latter emit a specific signal. It is here provided that the fluorescent properties of the plant parts be used, and that the latter be made detectable through exposure to light in corresponding wavelength ranges. The device serves in particular to acquire the grain loss at the ejector of the harvesting machine.

U.S. Pat. No. 4,360,998 provides a plurality of sensors on a sieve, which ascertain the grain quantities passing through the sieve making use of the light barrier principle. The quantity lost at the end of the sieve is extrapolated from the distribution of grain quantity over the length of the sieve. To this end, the sensors are arranged like a matrix on the sieve, and transmit their data to a computing unit, which ascertains the lost quantity and also informs the driver when a limit has been exceeded.

Due to the inadequate sensor arrangement, there is only an inadequate ability to regulate the changeable manipulated variables of the combine harvester based on the continuously changing separating behavior of the solid phases (grain and non-grain constituents) inside of the combine harvester. The tendency of sensors to become soiled frequently also poses a problem. For this reason, new sensors or sensor configurations are necessary for being able to reliably regulate combine harvesters based on the present phases.

### SUMMARY

The subject matter of the present patent application relates to a sensor unit for use in the multiphase flow of a harvesting machine, wherein the sensor unit exhibits sensors for transmitting and/or receiving electromagnetic radiation. In addition, the sensor unit has at least one device for acquiring flow parameters of the multiphase flow. The measuring values of the sensor unit can advantageously be used for controlling the operating mode of the harvesting machine.

### DETAILED DESCRIPTION

The object is to acquire as completely as possible the grain load of different conveying streams in a harvesting machine, in particular a combine harvester, so that an optimal control of the harvesting machine can be ensured, and the grain losses can be kept as low as possible. In addition, it has proven advantageous to acquire fluidic variables other than the grain quantity as well, so as to enable an optimal control of the harvesting machine. The measurement of these variables is also intended to be part of the solution according to the invention.

According to the invention, the object is achieved with a sensor unit according to claim 1. Advantageous embodiments are disclosed in the appended subclaims.

The sensor unit according to the invention for measuring the mass flow of solid phases of a biogenic multiphase flow as well as fluid mechanical variables for the gaseous phase preferably exhibits the following features:
1. The sensor incorporates the transducers (converters) for measuring the solid phases of a multiphase flow and fluid mechanical variables for the gaseous phase locally in a housing.
2. The solid phase of a multiphase flow is preferably measured transmissively, wherein the signal is attenuated and/or interrupted (FIG. 2). To this end, the sensor unit is given a fluidically favorable shape, e.g., that of a keel or a fin with a rounded leading edge curvedly running away from the surface of the fastening plane of the sensor unit. The sensor unit optionally exhibits a sensor tip, which protrudes as an extension of the upper edge running parallel to the fastening plane or directly out of the curvedly running leading edge, and is directed against the multiphase flow. The sensor tip is preferably shaped like a circular cone. The front area of the cone carries one or several sensors for measuring the flow rate, preferably one or more hot film sensors. The front cone area preferably consists of very readily heat conducting material (e.g., metal, preferably aluminum or copper), so that the hot film sensors can preferably be accommodated inside of the front cone area, thereby providing protection against environmental influences. The hot film sensors can optionally be secured to the surface of the front cone area. This configuration as a sensor tip advantageously prevents the development of a stagnation point for the flow, which promotes the accuracy and sensitivity of the measurement. The inclination of the symmetrical axis of the circular conical sensor tip relative to the fastening plane preferably ranges from 0° to 60°, especially preferably from 0° to 45°, and very especially preferably measures approx. 30°. The sensor unit is preferably arranged in such a way that its lateral walls run perpendicular or at least approximately perpendicular. The keel turns its narrowest side, the leading edge, toward the incoming airflow, and its longitudinal extension runs parallel to the airflow. As a result, the sensor unit advantageously exerts the least possible influence on the flow. The sensors for measuring the solid phase of the biogenic multiphase flow are here preferably arranged laterally on the keel-shaped sensor unit. The sensors are here preferably designed as a device that emits (transmitter) and/or receives (receiver) light, in particular laser light, or some other kind of electromagnetic radiation. LED's, laser diodes, halogen lamps or gas discharge lamps are preferably used as suitable electromagnetic radiation transmitters. The electromagnetic radiation preferably takes the form of a light grid, two-dimensionally bundled light or a light barrier. Suitable receivers include photodiodes, phototransistors or CMOS or CCD lines or also CMOS or CCD areas. The transmitters send out a signal, the attenuation or interruption of which is recorded and evaluated. The sensors (transmitters and receivers) are preferably located behind protective screens, which preferably seamlessly adjoin the surfaces of the lateral walls of the sensor unit. These protective screens are at least partially (more than 50% of the electromagnetic radiation passes through the protective screens) transparent to the emanating or incident electromagnetic radiation. In sensor units to be used as a reflector, the protective screens are at least partially sealed, or one (or several) reflecting surfaces are located inside of the housing, behind the protective screens. The attenuation or interruption of the beam path between two sensors is measured for transmission measurements. To this end, two sensor units are arranged in the multiphase flow, or a corresponding sensor (transmitter or receiver, complementary to the receiver or sensor of the other sensor unit) is located in the wall of the flow channel of the harvesting machine. Reflection measurements provide that the electromagnetic radiation of the particles be scattered in the multiphase flow, and thereby weakened. The backscattered electromagnetic radiation (scattered light) is acquired in the same sensor unit that sent it out. To this end, the sensor unit exhibits both transmitters and receivers. The reflection can also be increased by means of a reflector situated opposite the transmitter/receiver. The measuring signal then passes through the flow to be measured a second time. A preferred embodiment provides a combination of transmission and scattering measurements. The signals are here acquired by receivers in the sensor unit that sends out the signal, and by one (or several) receivers in a unit spaced apart, preferably parallel, from the sensor unit that sends out the signal (e.g., the wall). In a preferred embodiment, a sensor unit exhibits several sensors for transmitting or receiving electromagnetic radiation that are spaced a varying distance away from the fastening side of the sensor unit or from the leading edge. This makes it possible to acquire a profile for the grain stream. At a low grain load of the conveying airflow, individual grain detection is also possible as an option.
3. The fluid mechanical variables of the gaseous phase are preferably measured by measuring the static pressure, preferably with absolute pressure sensors, and the flow rate is preferably measured via hot film anemometry. Hot film anemometry is here based on the heat dissipating effect of a medium flowing by (here: the airflow of the stream of conveying air). The absolute pressure sensors preferably exhibit a membrane, which is seamlessly arranged in the sensor unit, preferably on its side, adjoining the surface of the sensor unit. The membrane then acts on pressure sensors according to prior art (e.g., piezoelectric sensors). However, other sensor constructions according to prior art are also possible. Measuring procedures other than hot film anemometry are also possible for flow rate measurement. The expert is aware that the sensors for measuring flow rate are to be arranged in the lateral walls of the sensor unit or in the leading edge, depending on the measuring principle. When using sensors for measuring the flow rate via hot film anemometry, at least one sensor is preferably arranged on each side of the sensor unit. The direction of flow can be inferred from the difference between the measurements on the opposite sides of the sensor unit. Given the optional presence of a sensor tip on the sensor unit, the sensors for measuring the flow rate are preferably exclusively or also located on the latter, very especially preferably at the front end of the tip, where the sensors are exposed to the directly oncoming multiphase flow. In an especially preferred embodiment, two or more similar flow sensors are arranged on the tip, so that the direction of flow can be inferred from different measuring results of the sensors. However, it is essential that the openings in the sensor unit that might here be present cannot become clogged or that measuring procedures be used in which no openings are necessary. As an option, additional sensors can be provided, in particular one or several temperature sensors, for example.
4. The housing of the sensor unit is fluidically shaped in such a way that (little or) no flow separation takes place, or only does so outside of the measuring range. Due to the special housing configuration, the angular sensitivity of the sensor unit is slight in terms of measuring the flow rate and static pressure. An angular independence of ±45° relative to the sensor transverse axis and ±10° relative to the sensor vertical axis is achieved. The housing preferably is made out of plastic. However, other housing materials are also possible, for example stainless steel or aluminum.
5. The housing of the sensor unit is advantageously shaped in such a way that no regions of reduced flow rates are encountered in the area of the sensors (flow separation, “wake spaces”, recirculation), which prevents or removes deposits of dust, etc. Special measures (tripwire, turbulators) generate a turbulent boundary layer. The turbulence increases the momentum exchange. As a result, the flow near the wall becomes higher in energy, and can more easily follow the profile contour. This prevents a bubble release of the flow, and facilitates heat exchange. The configuration of the outer shape of the sensor unit is optimized with computer-assisted simulation processes from prior art in such a way that the fluidic objectives (no flow separation if possible, no regions of reduced flow rates if possible).
6. The sensor unit is configured and positioned as noninvasively as possible and without any retroactive effect in relation to the fixed biogenic phase of the multiphase flow. This is achieved by preferably selecting the already described keel shape for the sensor unit. At the edge remote from the fastening plane or at the leading edge itself, the keel shape optionally exhibits a sensor tip that protrudes beyond the leading edge, and is directed against the oncoming flow. The sensor unit is preferably introduced into the multiphase flow in such a way that the leading edge is pointed opposite the airflow, and the longitudinal extension of the sensor unit is directed parallel to the direction of flow of the air. Given an arrangement underneath a sieve unit, the grains move with gravity, and are deflected from the vertical only by exposure to the airflow running essentially at a right angle thereto, thereby causing an air separation of the grain stream. In this way, the broadside of the sensor unit is advantageously not hit by the grains. Even any stones and other admixtures contained in the conveyed material move parallel to the lateral walls of the sensor unit, which thus is subject to less wear, and thereby avoiding a direct impairment of the sensors, which preferably are arranged in the lateral wall, with the exception of the flow rate sensors. The sensor units are preferably located underneath the separating plane resulting from the position of the sieve. At least one sensor unit is here used, which is preferably centrally arranged, and can maximally monitor the distance between a machine side and the middle of the machine (FIG. 7). If the sensor unit is equipped with sensors for transmitting or receiving electromagnetic radiation, the entire machine width can be monitored. However, several sensors arranged in parallel over the width of the machine are preferably used, so that a flow profile can be acquired. This makes it possible to measure distribution transverse to the conveying direction, which serves to ascertain the transverse distribution and increase in support point density for the control algorithm. In an especially preferred embodiment, the flow profile and separating curve are recorded over the length of the separating surface, and the sensors are also arranged accordingly. In principle, sensors can be arranged in any pattern that appears to make sense for optimizing the separating process.
7. The sensor unit preferably incorporates an evaluation unit for processing and transmitting the measured variables. The measured values are optionally relayed to an external evaluation unit, and only processed there. While the process parameters are preferably ascertained inside of the sensor from the measured variables, completely external processing is also possible.
8. The output signal of the sensor unit is preferably relayed to further processing via at least one data bus (CAN, LIN, . . . ). Wireless data transmission is also preferred. Further processing preferably takes place in a central data processing unit of the harvesting machine. It is further preferred that the central data processing take place in a mobile or stationary control unit, which receives the data of several harvesting machines, and that control data for the harvesting machine are ascertained and transmitted to the latter. Transmission here preferably takes place wirelessly.
9. The housing of the sensor unit is preferably configured is such a way that the sensor unit can be equipped (or not) with components for generating electrical power out of the oscillatory motion of the sensor unit. The energy generated from the wobbling motions is achieved using known methods from prior art for “energy harvesting”. In sensor units arranged on stationary walls of the harvesting machine, energy can also be supplied by means of conventional cable routings for electrical feed lines. As an option, the same lines can be used for power supply and data transmission.
10. In a preferred embodiment, two or more sensor units are situated in shared fastening devices. These fastening devices make it possible to quickly change out defective sensor units. In addition, they are preferably also configured to supply the sensor units with energy and/or establish the data connection to a central data processing device. In addition, the arrangement in fastening devices ensures that the positioning of the sensor units remains unchanged, and that, even after changing out one or several sensor units in a shared fastening device, no complicated adjustments are necessary for establishing the optical connection between the sensor units. In an especially preferred embodiment, the two parts of the fastening device that accommodate sensor units can be displaced relative to each other in such a way that the distance between the sensor units can be altered (set) without changing the sensor alignment, i.e., without any subsequent adjustment being necessary. To this end, for example, the connection of sensor units is telescoping, or the latter can be displaced on a shared mounting rail. Setting preferably takes place by mounting the fastening device with the prescribed distance between the sensor units. However, another preferred embodiment provides for the motor-driven adjustability of the distance between the sensor units. In the second case, adjustment preferably is controlled by the data processing device. In a preferred embodiment, fastening in the fastening devices takes place by placing the sensor units in recesses of the fastening devices, which ideally accommodate the fastening consoles of the sensor units in terms of shape, and there lock them detachably in place. For example, latching takes place by means of screws, clamping closures or similar approaches from prior art. Placing the sensor units into the recesses preferably also establishes the energy and data connection. Known approaches are also used here.
A preferred embodiment provides for a fastening device with a single recess for accommodating a single sensor unit. The sensor unit is detachably secured in the recess. This makes it possible to quickly change out the sensor unit. While placing the sensor unit into the recess, the energy and data connection to the sensor unit is also established.
11. Several sensors of a harvesting machine (combine harvester) preferably comprise a computerized network for providing new control variables for the harvesting machine.

The sensors according to the invention are advantageously used in the harvesting machine in positions where separation takes place.

When using several sensor units according to the invention in the harvesting machine, the sensor unit according to the invention makes it possible to ascertain the number of grains or a signal correlating with the density of the grain stream, as well as the machine part or sieve section in which the separation takes place. In addition, it can be determined how many grains or other plant material is put through at what location of the harvesting machine. This information can be used to homogenize and optimize the flow distribution in the harvesting machine. Furthermore, the information of the sensor units serves to control or regulate the machine settings, e.g., the motor speed, sieve width and the like.

In particular, it is now possible to acquire how many usable plant parts (grains) exit the harvesting machine without having been separated (direct loss determination).

In a first preferred embodiment, several sensors distributed over the length of the sieve are used. The separating curve is here first generated from the measured values, after which the losses are calculated with a model. An indirect loss determination is thus involved.

In a second preferred embodiment, only one sensor unit is inserted at the end of the separating surface. As a result, the losses are calculated/correlated directly from the measured values.

It is also advantageously possible to acquire the pressure ratios in the process of starting up the harvesting machine. To this end, differential pressure measurements between the pressure sensors of individual sensor units are preferably evaluated. Measuring the pressure ratios prior to the startup process here serves to calibrate the sensors to the ambient pressure. The absolute pressure is preferably used to characterize the flow resistance of the material layer, and correlates with the load (throughput) of the cleaning device.

### BRIEF DESCRIPTION OF THE DRAWINGS

FIG. 1 shows the sensor arrangements (circled areas) in a combine harvester according to prior art. Sensors are here located in the discharge areas of the crop separator, and are intended to acquire the loss.

FIG. 2 shows the principle arrangement of sensor units (transmitter and receiver) and their positioning relative to the directions of movement for the solid 101 and gaseous 100 phases. The particles 105 are illuminated in the laser field 104 of the transmitting sensor unit 102, and detected in the receiving sensor unit 103.

FIG. 3 shows the principle design of the sensor unit 200 according to the invention. Readily visible is the keel-shaped configuration of the sensor unit 200 with the leading edge 201, which faces the movement of the gaseous phase. The depicted sensor unit 200 further exhibits a hot film sensor 202 for determining the flow rate, and a pressure sensor 203 for ascertaining the static pressure. The optical sensor 204 has a strip-shaped design.

FIG. 4a to FIG. 4c schematically depict the sensor unit 200 in three views—a side view (FIG. 4a), a front view (leading edge—FIG. 4b), and a top view (assembly side—FIG. 4c). This embodiment exhibits a fastening console 205, which can be used to place the sensor unit 200 in a fastening device 207 and latch it in place therein.

FIG. 5a to FIG. 5c schematically depict a preferred embodiment of the sensor unit 200 in three views—a 3D view (FIG. 5a), a side view (FIG. 5b) and a front view (leading edge—FIG. 5c). By comparison to the embodiment on FIG. 4, the present embodiment exhibits a sensor tip 209, wherein the front area is composed of very readily heat conducting material, and carries the hot film sensor 202 in the interior or on its surface.

FIG. 6a to FIG. 6d schematically depict the arrangement of two sensor units 200 in a shared fastening device 207. The figures show the arrangement in a front view (FIG. 6a), a side view (FIG. 6b), a top view (assembly side—FIG. 6c) as well as a perspective view (FIG. 6d). The beam path 208 between the optical sensors (transmitter 2001 and receiver 2002) of the two sensor units 200 is schematically depicted on FIG. 6c and FIG. 6d.

FIG. 7 schematically depicts variants for the arrangement of sensor units 200 according to the invention underneath a sieve unit 106 in a side view (a) and from below (b). For example, the latter monitor one half the sieve width—arrangement (a), or just one segment 107 as in arrangement (b). The segments arise when the sieve is divided into strip-shaped sections running parallel to the direction of airflow. In arrangements (a) and (b), a respective sensor unit operates as a transmitter/receiver 2001 or as a receiver/reflector 2002. Arrangement (c) shows the use of sensor units 2001 that operate as a transmitter and receiver 2001 in the middle of the sieve width, but the latter only acquire the backscattered electromagnetic radiation, and do not monitor an area between two sensor units 200. Arrangement (d) makes it possible to monitor the changes in flux densities in a segment with pairs of sensor units 2001, 2002 situated one after the other in the direction of flow of the gaseous phase. The segments 107 are separated by webs 109, underneath which the sensor units 2001, 2002 are preferably located. If only the basket loss is to be acquired, it most often suffices to provide a pair of sensor units per machine side. However, it is advantageous to select an arrangement according to (d) for differentiated control of grain separation.

FIG. 8 and FIG. 9 show the preferred positions of sensor units 200 in combine harvesters with a straw walker 305 (FIG. 8) or rotor 304 (FIG. 9). At least two, preferably three or more sensor units 200 are here preferably situated underneath the straw walker 305 or rotor 304. At least two, preferably three or more sensor units 200 are preferably also situated underneath the upper sieve 301 and/or the lower sieve 302.

### DETAILED DESCRIPTION OF THE PREFERRED EMBODIMENTS

The following exemplary embodiment explains the structural design and use of the sensor unit, but without limiting the invention to this example.

In this exemplary embodiment, the sensor units according to the invention are used in pairs, with the first and second sensor units spaced a defined distance apart from each other. To this end, the sensor units exhibit consoles, which hold them in the recesses of the fastening device. Placing the sensor unit consoles into the fastening device also establishes contact with the plug connector located in the fastening devices or its counter-pieces in the consoles for purposes of electrical power supply and data exchange. The sensor units are 258 mm long (greatest expansion), and have a height of 60 mm. The thickness measures at most 25 mm. The sensor units are fabricated out of the injection moldable plastic Ultramid A3X2G5sw23187. The translucent material comprising the disk of the optical sensor is Makrolon 550115. The dimensions of the disk measure approx. 100 mm×30 mm. The disk is rounded to prevent stress at the corners. The leading edge of the sensor unit exhibits a radius of curvature of 60 mm from the baseline (edge on which the sensor unit rests) to the keel line (edge of the sensor unit running parallel to the baseline). The shaping of the leading edge was determined via computer-aided mathematical simulation.

The two keel lines of the sensor units run parallel to each other, are spaced 250 mm apart.

The sensors arranged in the first sensor unit are a transmitter for electromagnetic radiation, a hot film sensor for measuring the flow rate, as well as a pressure sensor for measuring the static pressure.

The second sensor unit exhibits a receiver for electromagnetic radiation, in particular the radiation emitted by the first sensor unit. In addition, a hot film sensor for measuring the flow rate along with a pressure sensor for measuring the static pressure are also provided.

Pairs of the sensor unit according to the invention are incorporated into the harvesting machine at the following locations:
Assembly 1: Several sensor unit pairs along the lower sieve of the cleaning device serve to acquire the separating curve (indirect loss determination).
Assembly 2: Several sensor unit pairs along the upper sieve of the cleaning device also acquire the separating curve for indirect loss determination.
Assembly 3: A sensor unit pair measures over the width of the lower sieve of the cleaning device, and thereby serves to determine the transverse distribution (e.g., correct the sloping influence, regulate the uniform transverse distribution).
Assembly 4: A sensor unit pair measures over the width of the upper sieve of the cleaning device, and thereby serves to determine the transverse distribution (e.g., correct for the sloping influence, regulate the uniform transverse distribution).
Assembly 5: Several sensor unit pairs measure the transverse distribution along the separating device (shaker/rotor) (e.g., to correct for sloping influence, regulate the uniform transverse distribution).
Assembly 6: Several sensor unit pairs measure behind the upper sieve (transition to cleaning), and thereby enable a direct loss determination.

### LIST OF REFERENCE NUMERALS

1 Cutting mechanism
2 Inclined conveyor
3 Slope compensation
4 Cross-flow blower
5 Preparation floor
6 Rotary elevator, tailings
7 Sieve box
8 Returns floor
9 Shaker
10 Shredder
11 Motor
12 Separator drum
13 Straw guide drum
14 Threshing drum
15 Driver cabin

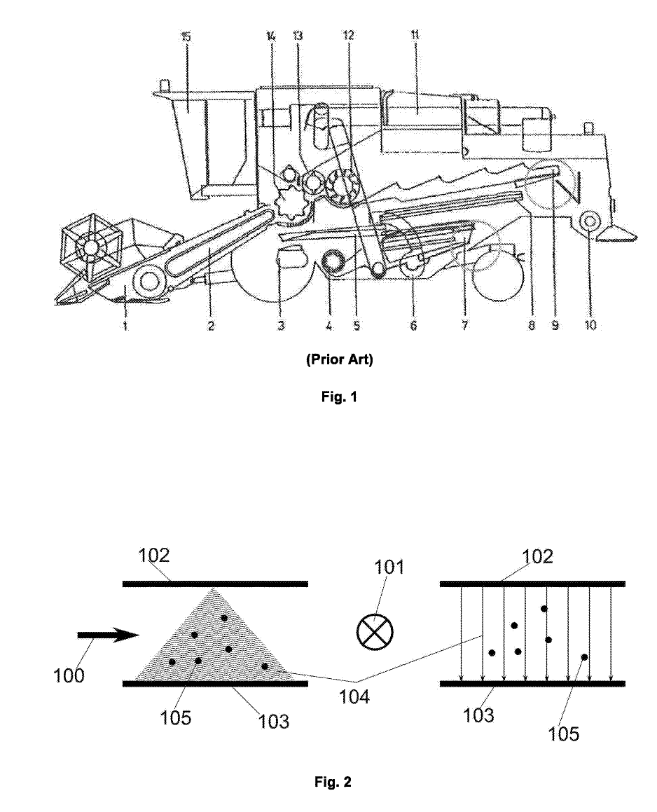

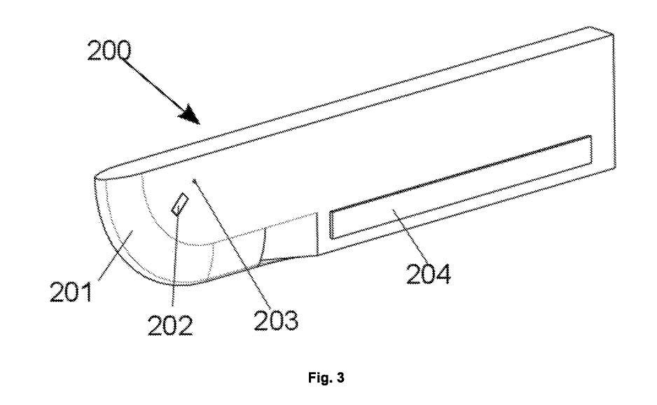

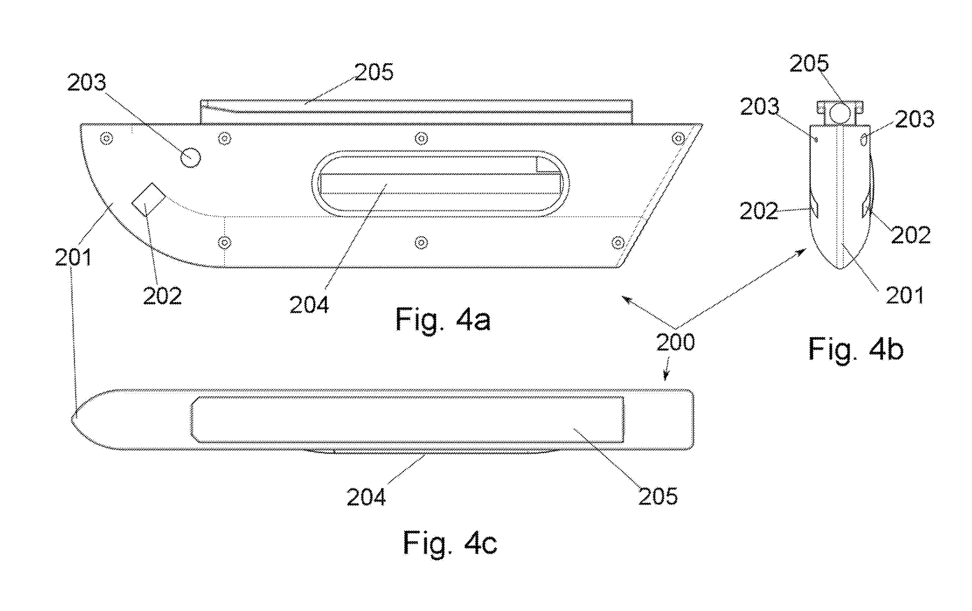

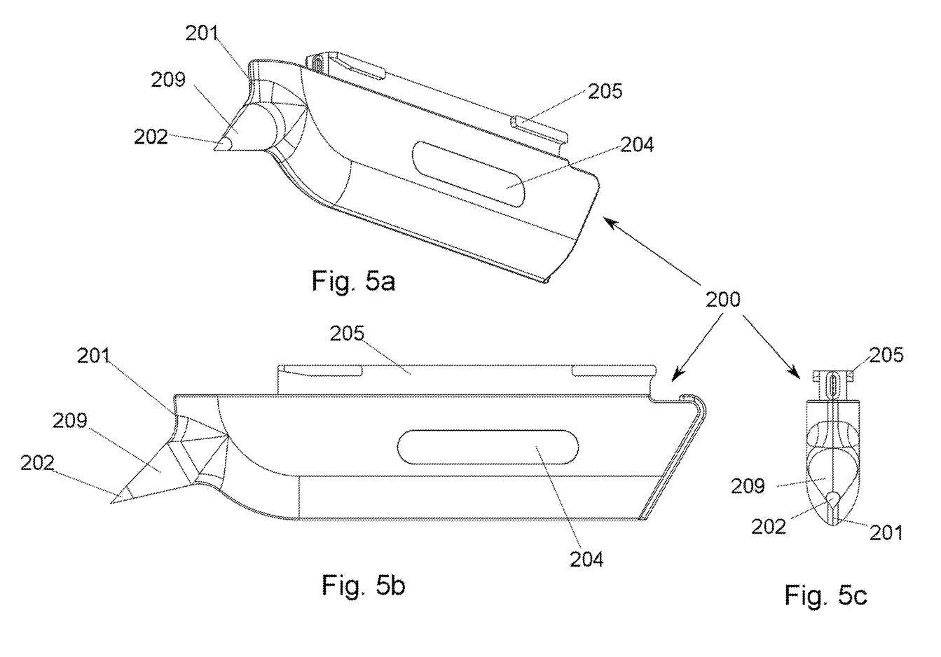

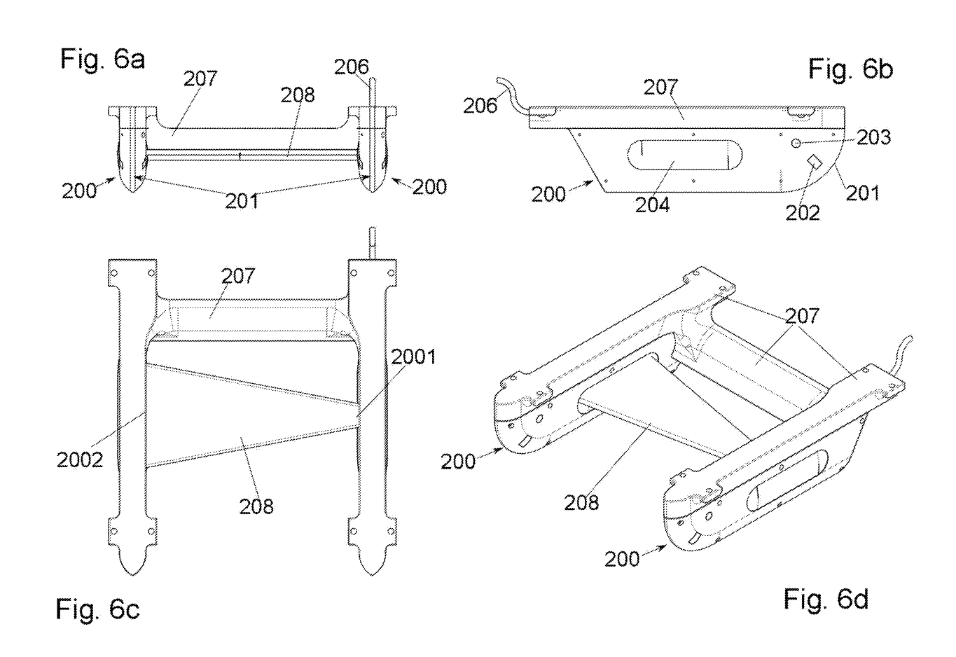

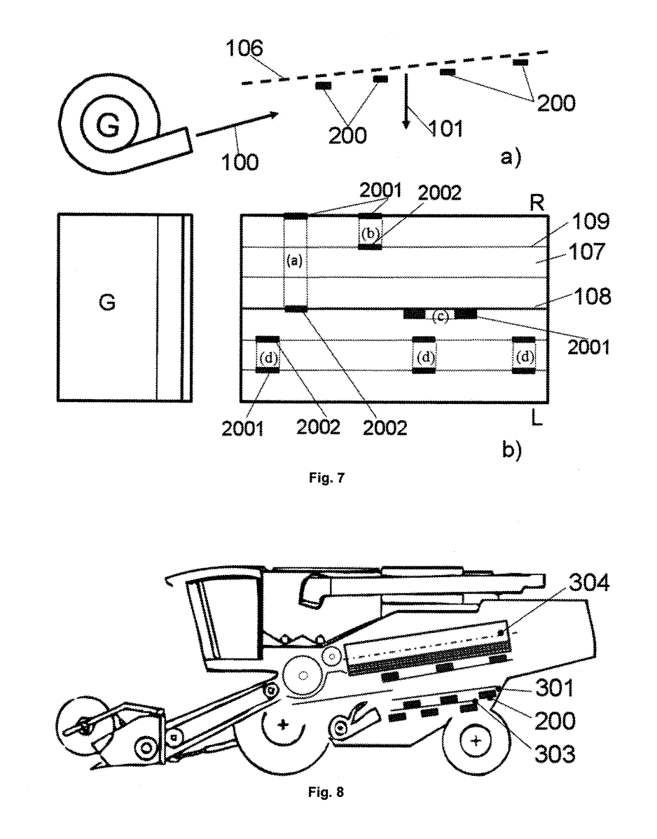

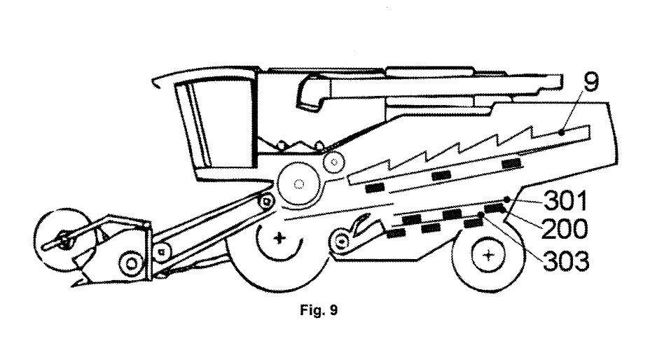

Circled details on FIG. 1: Areas in which grain loss sensors are positioned in prior art.
100 Conveying direction of gaseous phase
101 Conveying direction of solid phase
102 Transmitting sensor unit
103 Receiving sensor unit
104 Laser field
105 Grains
106 Separating plane (sieve)
107 Segment
108 Middle of cleaning (cleaning device)
109 Web between the segments
200 Sensor unit
2001 Transmitter/receiver
2002 Receiver/reflector
201 Specially shaped leading edge
202 Hot film sensor
203 Pressure sensor
204 Optical sensor
205 Fastening console
206 Energy supply/data line
207 Fastening device for sensor pair
208 Beam path between two sensor units
209 Sensor tip
301 Upper sieve
303 Lower sieve
304 Rotor
305 Straw walker
(a) . . . (d) Preferred sensor positions
G Blower
L Left machine side
R Right machine side

1. A sensor unit (200) for use in a multiphase flow of air and plant parts of a harvesting machine, wherein the sensor unit (200) exhibits at least one device for transmitting (2001) and/or at least one device for receiving (2001) or reflecting electromagnetic radiation (2002), characterized in that the sensor unit (200) exhibits at least one device for acquiring flow parameters, and the devices for transmitting and/or receiving electromagnetic radiation (2001, 2002) in order to detect usable plant parts as well as the device for acquiring flow parameters are together arranged in a housing, and incorporated into the multiphase flow in such a way that the leading edge (201) of the housing is rounded, curvedly runs away from the surface of the fastening plane of the sensor unit (200), and is directed against the airflow, and the longitudinal extension of the housing is directed parallel to the direction of airflow, and the sensor unit (200) is configured in such a way that no regions of slowed flow rates arise in the area of the sensors, and that no flow separation takes place, or only does so outside of the measuring range, wherein a turbulent boundary layer is generated between the housing exterior of the sensor unit (200) and the multiphase flow.

2. The sensor unit (200) according to claim 1, characterized in that the device (2001) for transmitting electromagnetic radiation exhibits at least one light-emitting diode or laser diode or at least one gas discharge pipe or at least one halogen lamp.

3. The sensor unit (200) according to claim 1, characterized in that the device for receiving (2001) electromagnetic radiation exhibits at least one photodiode or a phototransistor or a CCD arrangement.

4. The sensor unit (200) according to claim 1, characterized in that the device for acquiring flow parameters exhibits at least one hot film sensor (202) for acquiring the flow rate and/or an absolute pressure sensor.

5. The sensor unit (200) according to claim 1, characterized in that the sensor unit (200) exhibits electronic means for recording, processing and/or transmitting the measured sensor values.

6. The sensor unit (200) according to claim 1, characterized in that the sensor unit (200) is equipped with components for generating electrical power from the oscillatory motion of the sensor unit, and thereby supplied with energy via “energy harvesting”.

7. The sensor unit (200) according to claim 1, characterized in that the housing is keel-shaped in design, with a leading edge (201) that faces the direction of flow of the multiphase flow.

8. The sensor unit (200) according to claim 7, characterized in that the leading edge of the housing exhibits a sensor tip directed against the multiphase flow.

9. The sensor unit (200) according to claim 8, characterized in that the one or several sensors, preferably hot film anemometers, are located in or on the surface of the sensor tip or in the front area of the sensor tip.

10. The sensor unit (200) according to claim 7, characterized in that the leading edge (201) of the sensor unit (200) exhibits one or several tripwires for generating the turbulent boundary layer between the housing exterior and airflow.

11. The sensor unit (200) according to claim 1, characterized in that the sensor unit (200) exhibits a console (205), with which it can be detachably secured in a fastening device (207).

12. The sensor unit (200) according to claim 11, characterized in that fastening the sensor unit (200) in the fastening unit (207) establishes the energy and data connection.

13. The sensor unit (200) according to claim 11, characterized in that the fastening device (207) exhibits two or several recesses for accommodating sensor units (200), wherein the distance between the sensor units (200) can be set.

14. The sensor unit (200) according to claim 1, characterized in that the sensor unit (200) exchanges electromagnetic radiation for detecting usable plant parts with a device (2001) for transmitting and/or receiving electromagnetic radiation in a wall of the channel in which the multiphase flow runs.

15. Use of sensor units (200) according to claim 1, characterized in that the sensor units (200) are located underneath the rotor (304), the straw walker (305), the upper sieve (301) and/or the lower sieve (302) in such a way that the perpendicular on the lateral walls of the housing of the sensor units (200) runs at least approximately perpendicular to the directions of movement of the gaseous and solid phases.

16. The use of sensor units (200) according to claim 15, characterized in that at least two sensor units (200) are located underneath the straw walker (305) and/or the rotor (304), and are staggered in the direction of movement of the solid phase, also called the material transport direction.

17. The use of sensor units (200) according to claim 15, characterized in that the upper sieve (301) and/or lower sieve (302) are divided into segments parallel to the direction of movement of the gaseous phase, wherein opposing sensor units (200) monitor one segment and/or several segments.

18. The use of sensor units (200) according to claim 15, characterized in that at least two opposing sensor unit pairs (200) are located one after the other under the upper sieve (301) and/or lower sieve (302), staggered in the direction of movement of the gaseous phase, making them suitable for acquiring the change in grain separation in relation to the longitudinal direction of the sieves.

19. The use of sensor units (200) according to claim 15, characterized in that the signals of the sensor units (200) are used to control or regulate the harvesting machine or machine settings, for example the blower speed, the sieve width and the like.
